(19) United States
(12) Patent Application Publication
(10) Pub. No.: US 2021/0139014 A1
(43) Pub. Date: May 13, 2021

(54) DYNAMIC POWER SPLITTING CONTROL IN HYBRID VEHICLES

(71) Applicant: SF Motors, Inc., Santa Clara, CA (US)

(72) Inventors: Ruxiu Zhao, Santa Clara, CA (US); Min Tian, Santa Clara, CA (US); Tung-Yan Wu, Santa Clara, CA (US); Zhensheng Yuan, Santa Clara, CA (US); Yinghan Xu, Santa Clara, CA (US)

(21) Appl. No.: 16/680,086

(22) Filed: Nov. 11, 2019

(51) Int. Cl. B60W 20/12; B60W 30/188; B60W 10/06; B60W 10/08; B60W 50/06

(52) U.S. Cl. CPC B60W 20/12; B60W 30/188; B60W 20/20; B60W 10/08; B60W 50/06; B60W 10/06

(57) ABSTRACT

Provided herein are systems and methods for allocating power distribution in hybrid vehicle drivetrains. An engine instrumentation unit can acquire engine measurements on a hybrid drivetrain of a vehicle. The engine measurements can include a fuel use measurement of a combustion engine and a battery use measurement of an electric motor. A vehicle control unit can maintain a power distribution profile. Each power distribution profile can define a power allocation to the combustion engine and a power allocation to the electric motor specified for engine measurements as associated with an environmental condition. The vehicle control unit can compare the engine measurements. The vehicle control unit can select a power distribution profile based on the comparison. The vehicle control unit can set a power splitter to transfer of the mechanical power from the combustion engine and the electric motor to a differential unit in accordance with the power distribution profile.

### BACKGROUND

A vehicle can include one or more components to generate and transfer mechanical power to a driving surface to propel the vehicle.

### SUMMARY

The present disclosure is directed to systems and methods of allocating power distribution in drivetrains of hybrid vehicles. A vehicle control unit of a hybrid vehicle can maintain a set of power distribution profiles pre-generated by a remote server. The hybrid vehicle can have a drivetrain with an internal combustion engine and an electric motor to control propulsion of the hybrid vehicle. Each power distribution profile can specify a predetermined optimal power allocation to the internal combustion engine and a power allocation to the electric motor for specified engine measurements. The specified engine measurements can include a fuel use metric by the internal combustion engine and a battery use metric by the electric motor. During the operation of the hybrid vehicle, the vehicle control unit can identify engine measurements from an engine instrumentation unit of the vehicle. With the identification, the vehicle control unit can feed the engine measurements acquired from the instrumentation unit to the power distribution profiles to identify a power distribution profile with matching engine measurements. In accordance with the identified power distribution profile, the vehicle control unit can determine a power allocation for the internal combustion engine and a power allocation for the electric motor. The vehicle control unit can configure a power splitter of the drivetrain using the determined power allocation for the internal combustion engine and electric motor. By having the power distribution profiles pre-generated by the remote server, the optimal power distribution across the internal combustion engine and the electric motor can be determined, without reliance on complex classification algorithms or specialized hardware components.

At least one aspect is directed to a system to allocate power distribution in drivetrains of hybrid vehicles. The system can include a hybrid drivetrain disposed in a vehicle. The hybrid drivetrain can include a differential unit to control propulsion of the vehicle. The hybrid drivetrain can include an internal combustion engine to convert fuel to mechanical power to provide to the differential unit. The hybrid drivetrain can include an electric motor to convert electrical energy drawn from a battery pack to mechanical power to provide to the differential unit. The hybrid drivetrain can include a power splitter to control transfer of the mechanical power from the internal combustion engine to the differential unit and of the mechanical power from the electric motor to the differential unit. The system can include an engine instrumentation unit disposed in the vehicle to acquire a plurality of engine measurements on the hybrid drivetrain of the vehicle. The plurality of engine measurements can include a fuel use measurement of the internal combustion engine and a battery use measurement of the electric motor. The system can include a vehicle control unit including one or more processors disposed in the vehicle. The vehicle control unit can maintain a plurality of power distribution profiles. Each of the power distribution profiles can define a first power allocation to the internal combustion engine and a second power allocation to the electric motor specified for a plurality of engine measurements identified as associated with one of a plurality of environmental conditions. The vehicle control unit can compare the plurality of engine measurements acquired from the engine instrumentation unit with the plurality of engine measurements specified by at least one of the plurality of power distribution profiles. The vehicle control unit can select a power distribution profile from the plurality of power distribution profiles based on the comparison between the plurality of engine measurements acquired from the engine instrumentation unit with the plurality of engine measurements specified by the power distribution profile. The vehicle control unit can identify, from the power distribution profile selected from the plurality of power distribution profiles, the first power allocation to internal combustion engine and the second power allocation to the electric motor for one of the plurality of environmental conditions. The vehicle control unit can set the power splitter to transfer of the mechanical power from the internal combustion engine and the mechanical power from the electric motor to the differential unit in accordance with the first power allocation and the second power allocation.

At least one aspect is directed to a hybrid or other type of vehicle. The vehicle can include a hybrid drivetrain. The hybrid drivetrain can include a differential unit to control propulsion. The hybrid drivetrain can include an internal combustion engine to convert fuel to mechanical power to provide to the differential unit. The hybrid drivetrain can include an electric motor to convert electrical energy drawn from a battery pack to mechanical power to provide to the differential unit. The hybrid drivetrain can include a power splitter to control transfer of the mechanical power from the internal combustion engine to the differential unit and of the mechanical power from the electric motor to the differential unit. The vehicle can include an engine instrumentation unit to acquire a plurality of engine measurements on the hybrid drivetrain. The plurality of engine measurements can include a fuel use measurement of the internal combustion engine and a battery use measurement of the electric motor. The vehicle can include a vehicle control unit including one or more processors. The vehicle control unit can maintain a plurality of power distribution profiles. Each of the power distribution profiles can define a first power allocation to the internal combustion engine and a second power allocation to the electric motor specified for a plurality of engine measurements identified as associated with one of a plurality of environmental conditions. The vehicle control unit can compare the plurality of engine measurements acquired from the engine instrumentation unit with the plurality of engine measurements specified by at least one of the plurality of power distribution profiles. The vehicle control unit can select a power distribution profile from the plurality of power distribution profiles based on the comparison between the plurality of engine measurements acquired from the engine instrumentation unit with the plurality of engine measurements specified by the power distribution profile. The vehicle control unit can identify, from the power distribution profile selected from the plurality of power distribution profiles, the first power allocation to internal combustion engine and the second power allocation to the electric motor for one of the plurality of environmental conditions. The vehicle control unit can set the power splitter to transfer of the mechanical power from the internal combustion engine and the mechanical power from the electric motor to the differential unit in accordance with the first power allocation and the second power allocation.

At least one aspect is directed to a method of allocating power distribution in drivetrains of hybrid vehicles. The method can include acquiring, by an engine instrumentation engine disposed in a vehicle, a plurality of engine measurements on a hybrid drivetrain of the vehicle. The hybrid drivetrain can include an internal combustion engine and an electric motor. The plurality of engine measurements can include a fuel use measurement of an internal combustion engine and a battery use measurement of the electric motor. The method can include maintaining, by a vehicle control unit having one or more processors disposed in the vehicle, a plurality of power distribution profiles. Each of the power distribution profiles can define a first power allocation to the internal combustion engine and a second power allocation to the electric motor specified for a plurality of engine measurements identified as associated with one of a plurality of environmental conditions. The method can include comparing, by the vehicle control unit, the plurality of engine measurements acquired from the engine instrumentation unit with the plurality of engine measurements specified by at least one of the plurality of power distribution profiles. The method can include selecting, by the vehicle control unit, a power distribution profile from the plurality of power distribution profiles based on the comparison between the plurality of engine measurements acquired from the engine instrumentation unit with the plurality of engine measurements specified by the power distribution profile. The method can include identifying, by the vehicle control unit, from the power distribution profile selected from the plurality of power distribution profiles, the first power allocation to internal combustion engine and the second power allocation to the electric motor for one of the plurality of environmental conditions. The method can include setting, by the vehicle control unit, a power splitter to transfer of mechanical power from the internal combustion engine and mechanical power from the electric motor to a differential unit of the hybrid drivetrain in accordance with the first power allocation and the second power allocation.

At least one aspect is directed to a method of providing vehicle control units to allocate power distribution in drivetrains of hybrid vehicles. The method can include providing a vehicle control unit including one or more processors in a hybrid vehicle. The vehicle control unit can maintain a plurality of power distribution profiles. Each of the power distribution profiles can define a first power allocation to an internal combustion engine and a second power allocation to an electric motor specified for a plurality of engine measurements identified as associated with one of a plurality of environmental conditions. The vehicle control unit can compare the plurality of engine measurements acquired from an engine instrumentation unit with the plurality of engine measurements specified by at least one of the plurality of power distribution profiles. The vehicle control unit can select a power distribution profile from the plurality of power distribution profiles based on the comparison between the plurality of engine measurements acquired from the engine instrumentation unit with the plurality of engine measurements specified by the power distribution profile. The vehicle control unit can identify, from the power distribution profile selected from the plurality of power distribution profiles, the first power allocation to internal combustion engine and the second power allocation to the electric motor for one of the plurality of environmental conditions. The vehicle control unit can set a power splitter to transfer of the mechanical power from the internal combustion engine and the mechanical power from the electric motor to the differential unit in accordance with the first power allocation and the second power allocation.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a diagram depicting an example environment for electric vehicles;

FIG. 2 is a block diagram depicting an example system to allocate power distribution in drivetrains of hybrid vehicles;

FIG. 3 is a flow diagram of an example method of allocating power distribution in drivetrains of hybrid vehicles;

FIG. 4 is a flow diagram of an example method of allocating power distribution in drivetrains of hybrid vehicles;

FIG. 5 is a flow diagram of an example method of providing vehicle control units to allocate power distribution in drivetrains of hybrid vehicles; and

FIG. 6 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of allocating power distribution in drivetrains of hybrid vehicles. The various concepts introduced above and discussed in greater detail below may be implemented in any of numerous ways.

Described herein are systems and methods of allocating power distribution in drivetrains of hybrid vehicles. Vehicular settings can include vehicles, such as electric vehicles, hybrid vehicles, fossil fuel powered vehicles, automobiles, motorcycles, passenger vehicles, trucks, planes, helicopters, submarines, or vessels. A hybrid vehicle can have two different sources of power to propel the vehicle. The two sources of power housed in the hybrid vehicle can include an electric generator to provide electrical power to an electric motor and a fuel reservoir to provide fuel to an internal combustion engine. The components associated with these two sources of power can be arranged in a drivetrain of the hybrid vehicle and connected to one another in series or in parallel, or in other configurations.

One of the components in the drivetrain of the hybrid vehicle can include a power splitter (also referred herein as a power combiner). The power splitter can control the amounts of power drawn from the electric generator and the internal combustion engine, and can apply a control strategy in drawing the power from these two sources. As the vehicle travels through different environment, the optimal control strategy can vary. In a series hybrid drivetrain, one control strategy can include using a battery pack as the sole power source until a predefined state-of-charge (SOC) is reached. Once reached, power from the internal combustion engine can be drawn to charge the battery pack and serve as an auxiliary power source. This control strategy, however, can result in the limiting of the performance of the vehicle while the battery pack serves as the sole source of power. This may be because battery packs in series hybrid vehicles may have lower power capabilities than battery packs in pure electric vehicles. In addition, the control strategy can also result to a large discharge current drawn through the battery pack, leading to high battery electrical stress, high heat loss, use of more thermal coolant, and shorter battery life.

Another approach can involve using different power splitting modes to configure the power splitter for different operation regions. Each operation region may be predefined based on various characteristics of the drivetrain and vehicle, such as battery SOC and vehicle speed. This approach, however, may not be intelligent or robust enough to account for system characteristics under real driving conditions in determining which operation region to select for the power splitter. Other approaches can attempt to remedy of these drawbacks by employing dynamic programming techniques to aim at a dynamic power splitting control strategy. But all these approaches may be highly dependent on a priori knowledge of the future route of the vehicle. As a consequence, such approaches can entail the incorporation of complex hardware and software, such as global positioning systems (GPS) and geographic information systems (GIS). The incorporation of such components may pose significant challenges in achieving dynamic control strategies. This challenge may be especially difficult, given the consideration that the time constraint for computations are to occur in response to fast-changing driving conditions.

To achieve the optimal vehicle performance, energy consumption of the battery pack, and fuel economy of the engine, on-board measurements of the vehicle drivetrain can be leveraged by a vehicle control unit in the vehicle. Using the measurements, the current driving condition can be determined via driving pattern recognition. The vehicle control unit can be an embedded system with microprocessors and memory to control various functions of the drivetrain. The vehicle can have one or more instrumentation units to acquire various measurements on the vehicle drivetrain. The vehicle control unit can be provided with a power-splitting ratio (PSR) table specifying a ratio of power to be drawn from the electric motor and from the internal combustion engine in propelling the vehicle. The PSR table may have been pre-calculated by a remote server using sample driving cycles to optimize the balance between battery pack load stress and engine fuel economy for various driving conditions as represented in the driving cycles. The optimization process can be performed by the remote server using a dynamic programming methods.

As the vehicle is traveling through the environment, the vehicle control unit can acquire measurements on the drivetrain, such as fuel use by the internal combustion engine, battery power drawn from the battery pack, and an engine temperature, among others. Using the acquired measurements, the vehicle control unit can perform a lookup for the respective power ratio from the PSR table. Once the PSR value is identified from the table, the vehicle control unit can determine a power distribution between the battery pack and the internal combustion engine. As power commands are received via vehicle controls from the driver of the vehicle, the vehicle control unit can set and adjust the power distribution to be applied to the hybrid drivetrain. In receiving the power distribution, the internal combustion engine can adjust the speed and torque to provide the desired mechanical power, while maintaining an optimal fuel consumption. Additionally, the electric energy drawn from the battery pack to provide to the electric motor can be adjusted to provide the target mechanical power, while also maintaining an optimal amount of load stress on the battery pack.

Compared to the other approaches, the acquisition of the measurements and the lookup of the PSR table on the vehicle control unit can be performed with low computational burden on the processors. Moreover, the vehicle control unit can achieve dynamic power splitting control between engine fuel efficiency and battery pack load stress. In this manner, the overall vehicle efficiency, travel range, and battery lifetime can be improved. Meanwhile, vehicle performance may not be limited, since both power sources can supply power, as opposed to one or the other. The resulting high-level distribution values can translate to the vehicle level for a balanced performance and energy consumption efficiency, extending vehicle range and battery pack lifetime, among other improvements.

FIG. 1, among others, depicts a diagram of an environment 100 for electric vehicles. The environment 100 can include at least one vehicle 105, such as a hybrid vehicle. The vehicle 105 can be any type of vehicle with more than one source of power such as an internal combustion engine and a battery pack. The vehicle 105 can be any type of transportation vehicle, such as an automobile (e.g., a passenger sedan, a truck, a bus, or a van), motorcycle, an airplane, a helicopter, a locomotive, or a watercraft, among others. The vehicle 105 can travel through any type environment. For example, as depicted, the vehicle 105 can traverse through an urban environment 110, a mountainous terrain 115, a suburban environment 120, or a highway 125, among others. As the vehicle 105 traverses the different types of environment 100, the power consumed by the drivetrain can differ in order to maintain the same speed or acceleration. For example, to maintain the same velocity, the vehicle 105 can apply a higher motor torque in the mountainous terrain 115 than on a relatively planar surface, such as the highway 125. With such disparities, the optimal control strategy for drawing power from multiple sources to control propulsion of the vehicle 105 can differ among the different type of environment 100.

FIG. 2, among others, depicts a block diagram depicting a system 200 to allocate power distribution in drivetrains of hybrid vehicles. The system 200 can include the vehicle 105. The vehicle 105 in the system 200 can be traveling through the environment 100. The vehicle 105 can include at least one drivetrain 202 (sometimes referred herein as a hybrid drivetrain or a powertrain). The drivetrain 202 can include one or more components disposed in the vehicle 105 (e.g., along a chassis frame of the vehicle 105) to control propulsion of the vehicle 105. The drivetrain 202 can include multiple sources of power (e.g., electric and petrochemical) to draw from in controlling the propulsion. The drivetrain 202 can deliver mechanical power from the vehicle 105 to the environment 100 via any drive wheel configuration, such as a rear-wheel drive, a front-wheel drive, a four-wheel drive (e.g., as depicted), or an all-wheel drive, among others.

The drivetrain 202 can house, contain, or otherwise include multiple sources of mechanical power. The drivetrain 202 can include at least one electric motor system 212. The electric motor system 212 can include one or more components disposed in the vehicle 105. The electric motor system 212 can rely on electrical power to provide propulsion for the vehicle 105. The electric motor system 212 can convert the electric power into mechanical power to deliver to the environment 100 and propel the vehicle 105. The drivetrain 202 can include at least one internal combustion engine (ICE) power system 214. The ICE power system 214 can include one or more components disposed in the vehicle 105. The ICE power system 214 can rely on fuel to provide propulsion for the vehicle 105. The ICE power system 214 can convert fuel (e.g., petrochemical fuel) into mechanical power by combustion to deliver to the environment 100 and to propel the vehicle 105.

Within the drivetrain 202, the electric motor system 212 and the ICE power system 214 can be coupled (e.g., mechanically or electrically) with each other in any configuration. The coupling can be with respect to other components of the drivetrain 202 to deliver mechanical power from the vehicle 105 to the environment 100. The configuration for the coupling of the electric motor system 212 and the ICE power system 214 can include: a series hybrid (e.g., as depicted), a parallel hybrid, or a series-parallel hybrid, among others. In the series hybrid configuration, the ICE power system 214 can be mechanically coupled with the electric motor system 212 to deliver mechanical power through the electric motor system 212 to the other components of the drivetrain 202. The electric motor system 212 can convert the mechanical power delivered from the ICE power system 214 into electrical power to supply to the components of the electric motor system 214. In the parallel hybrid configuration, both the electric motor system 212 and the ICE power system 214 can be coupled with other components of the drivetrain 202 to provide mechanical power separately. In the series-parallel hybrid configuration, the ICE power system 214 can be mechanically coupled with the electric motor system 212 and other components of the drivetrain 202 to deliver mechanical power to both.

The electric motor system 212 can include at least one battery pack 220. The battery pack 220 can be disposed within the vehicle 105. The battery pack 220 can hold, store, and maintain electrical power for the electric motor system 212, as well as other components of the vehicle 105. The battery pack 220 can be electrically coupled with one or more other components of the electric motor system 212. The battery pack 220 can house, contain, or otherwise include a set of batteries to maintain electric power. The batteries of the battery pack 220 can be, for example, a lithium-ion battery, a lithium polymer battery, a molten salt battery, a nickel metal hydride battery, a nickel cadmium battery, a zinc-air battery, among others. The battery pack 220 can discharge electric current (e.g., in the form of direct current (DC)) from the batteries to supply electrical power to the other components of the electric motor system 212 and the vehicle 105. The battery pack 220 can also receive electric current to recharge the batteries to hold and maintain electrical power for the vehicle 105.

The electric motor system 212 can include at least one electric motor 222. The electric motor 222 can be disposed within the vehicle 105. The electric motor 222 can be electrically coupled with one or more other components of the electric motor system 212, including the battery pack 220. The electric motor 222 can receive electric power from the battery pack 220 via the electric coupling. The electric motor 222 can be also mechanically coupled with one or more components of the drivetrain 202 to deliver mechanical power through the drivetrain 202. The electric motor 222 can convert the electric power originating from the battery pack 220 to mechanical power to provide to the other components of the drivetrain 202 to propel the vehicle 105 through the environment 100. The electric motor 222 can be a direct current (DC) motor, such as a brushed direct current (DC) motor, a brushless direct current electric motor (BLDC motor), or a switched reluctance motor (SRM), among others. The electric motor 222 can also be an alternating current (AC) motor, such as a permanent magnet synchronous motor (PMSM), a synchronous reluctant motor (SyRM), and a wound rotor induction motor (WRIM), among others.

The electric motor system 212 can include at least one regulator unit 224 (sometimes referred herein as a voltage inverter and converter unit). The regulator unit 224 can be disposed within the vehicle 105. The regulator unit 224 can be electrically coupled with one or more components of the electric motor system 212. For example, as depicted, in the electric motor system 212, the regulator unit 224 can be coupled between the battery pack 220 and the electric motor 222 in series. The regulator unit 224 can include at least one inverter component. The electrical energy from the battery pack 220 can be in the form of direct current. The inverter component can convert electrical power in the form of direct current (DC) to alternating current (AC) to power the electric motor 222. The regulator unit 224 can include the inverter component when the electric motor is an AC motor. Otherwise, the regulator unit 224 can lack the inverter component when the electric motor 222 is a DC motor. The regulator unit 224 can also include at least one converter component. The converter component can alter or change a voltage of the electrical power received from the battery pack 220 to match the electric motor 222. For example, the converter component can be a step-up voltage converter to increase the voltage of the electrical power supplied to the electric motor 222.

The electric motor system 212 can include at least one capacitor unit 226 (also referred herein as a flywheel unit or charge storing unit). The capacitor unit 226 can be disposed in the vehicle 105. The capacitor unit 226 can be electrically coupled with one or more components of the electric motor system 212, such as the battery pack 220 and the electric motor 222 (e.g., via the regulator unit 224). The capacitor unit 226 can receive electrical energy induced from kinetic energy of the vehicle 105 (e.g., when slowing down or braking) moving through the environment 100. The capacitor unit 226 can include at least one capacitor or flywheel mechanism to store and maintain the electrical energy. When no electrical energy is received, the capacitor unit 226 can release the electric energy to charge the battery pack 220.

The electric motor system 212 can include at least one generator unit 228. The generator unit 228 can be disposed in the vehicle 105. The generator unit 228 can be electrically coupled with one or more other components of the electric motor system 212, such as the battery pack 220. The generator unit 228 can be mechanically coupled with the ICE power system 214. Mechanically coupled, the generator unit 228 can receive the mechanical power generated by the ICE power system 214. The generator unit 228 can convert the mechanical power to electric power. Upon conversion, the generator unit 228 can supply and provide the electric power to the remainder of the electric motor system 212. For example, the generator unit 228 can provide the electric power to charge the battery pack 220. The generator unit 228 can also supply the electric power to the electric motor 222 to convert the electric power again to mechanical power to propel the vehicle 105 through the environment 100.

The electric motor system 212 can include at least one charger unit 230. The charger unit 230 can be disposed in the vehicle 105. The charger unit 230 can be electrically coupled with one or more components of the electric motor system 212, such as the battery pack 220 and the generator unit 228. For example, the charger unit 230 can be coupled in series between the battery pack 220 and the generator unit 228. The charger unit 230 can receive the electrical power generated by the generator unit 228. The charger unit 230 can regulator or control the amount of electrical power provided to charge of the battery pack 220 from the electrical power converted from the mechanical power by the generator unit 228.

The ICE power system 214 can include at least one fuel reservoir 232. The fuel reservoir 232 can be disposed in the vehicle 105. The fuel reservoir 232 can secure, contain, or otherwise maintain fuel for the ICE power system 214 (e.g., in a cavity of the fuel reservoir 232). The fuel can be a fluid or liquid substance, and include, for example, gasoline (or other fossil fuels), diesel, biodiesel, methanol, ethanol, propane, natural gas, liquefied petroleum gas (LPG), and hydrogen, among others. The fuel held within the fuel reservoir 232 can be used to generate mechanical power from the ICE power system 214. The fuel reservoir 232 can be fluidly coupled with one or more other components of the ICE power system 214. Through the fluid coupling, the fuel reservoir 232 can receive the fuel from an outside source (e.g., a fuel dispenser such as a gas pump). The fuel reservoir 232 can also supply, convey, or otherwise provide the fuel to the other components of the ICE power system 214 via the fluid coupling.

The ICE power system 214 can include at least one internal combustion engine 234. The internal combustion engine 234 can be disposed in the vehicle 105. The internal combustion engine 234 can be fluidly coupled with one or more other components of the ICE power system 214, such as the fuel reservoir 232. Fluidly coupled, the internal combustion engine 234 can receive the fuel from the fuel reservoir 232. The internal combustion engine 234 can be a heat engine, and can convert the fuel to mechanical power via combustion. The combustion of the fuel within the internal combustion engine 234 can turn one or more components of the internal combustion engine 234 to provide the mechanical power. The internal combustion engine 234 can be mechanically coupled with one or more other components of the drivetrain 202. Mechanically coupled, the internal combustion engine 234 can deliver the mechanical power to the other components of the drivetrain 202.

The drivetrain 202 can include at least one transmission shaft 236 (sometimes referred herein as a shaft or a driveshaft). The transmission shaft 236 can be disposed within the vehicle 105. The transmission shaft 236 can be mechanically coupled with the electric motor system 212 (e.g., via the electric motor 224), the ICE power system 214 (e.g., via the internal combustion engine 234), the power splitter 216, or any of these components. Mechanically coupled, the transmission shaft 236 can receive the mechanical power from the electric motor system 212 and the ICE power system 214. The transmission shaft 236 can transfer mechanical power to other components of the drivetrain 202. The other components to which the transmission shaft 236 can transfer the mechanical power can be disposed in the vehicle 105 at a distance separate from the electric motor system 212 or the ICE power system 214. For example, the transmission shaft 236 can transfer the mechanical power toward the forward of the vehicle 105 (e.g., generally depicted toward top) and toward the rear of the vehicle 105 (e.g., generally depicted toward bottom) via a transfer case in the drivetrain 202.

The drivetrain 202 can include at least one differential unit 218 (sometimes referred herein as a transmission unit or a mechanical transmission). The differential unit 218 can be disposed within the vehicle 105, and can include one or more components, such as gears, gear trains, and a housing. The differential unit 218 can be mechanically coupled with the transmission shaft 236, the electric motor system 212 (via the transmission shaft 236), and the ICE power system 214 (via the transmission shaft 236 or the electric motor system 212). Mechanically coupled, the differential unit 218 can receive the mechanical power from the electric motor system 212 or the ICE power system 214, or both. The differential unit 218 can further transfer the mechanical power to other components of the drivetrain 202. The differential unit 218 can also regulate or control the amount of mechanical power transferred out to the other components of the drivetrain 202, in response to the vehicle 105 performing a turn while moving through the environment 100.

The drivetrain 202 can include a set of drive axles 238, such as a front axle 238 (depicted toward the top) and a back axle 238 (depicted toward the bottom). Each drive axle 238 can be at least partially disposed within the vehicle 105, and can be mechanically coupled with one or more components of the drivetrain 202. Each drive axle 238 can receive the mechanical power from the differential unit 218 (via the transmission shaft 236), the transmission shaft 236 (via the differential unit 218), the electric motor system 212 (via the transmission shaft 236), and the ICE power system 214 (via the transmission shaft 236 or the electric motor system 212). By rotating, the drive axle 238 can also transfer the mechanical power to the environment 100 to propel the vehicle 105. The front drive axle 238 can transfer the mechanical power from towards the front of the vehicle 105 to the environment 100, and the rear drive axle 238 can transfer the mechanical power from towards the rear of the vehicle 105 to the environment 100.

The vehicle 105 can include a set of wheels 240. The vehicle 105 can include any number of wheel 240, ranging from 2 to 8. For example, as depicted, the vehicle 105 can have four wheel 240, a front-left wheel, a front-right wheel, a rear-left wheel, and a rear-right wheel. Each wheel 240 can be disposed at least partially in the vehicle 105, and can be mechanically coupled with one or more components of the drivetrain 202. Each wheel 240 can be mechanically coupled with at least one of the components of the drivetrain 202, such as the drive axle 238, the differential unit 218 (via the transmission shaft 236), the transmission shaft 236 (via the differential unit 218), the electric motor system 212 (via the transmission shaft 236), and the ICE power system 214 (via the transmission shaft 236). Mechanically coupled, each wheel 240 can receive the mechanical power from the electric motor system 212 or the ICE power system 214 of the drivetrain 202 in the vehicle 105. Each wheel 240 can also transfer the mechanical power from the electric motor system 212 or the ICE power system 214 to the environment 100 to propel the vehicle 105 in the environment 100.

The drivetrain 202 can include at least one power splitter 216 (sometimes referred herein as a power splitting unit or a power combiner). The power splitter 216 can be disposed in the vehicle 105. The power splitter 216 can be mechanically or electrically coupled with the electric motor system 212 and the ICE power system 214. The coupling of the power splitter 216 with the electric motor system 212 and the ICE power system 214 can vary based on the arrangement of the drivetrain 202. When the electric motor system 212 and the ICE power system 214 are coupled in series (e.g., as depicted), the power splitter 216 can be mechanically coupled in between the electric motor system 212 and the ICE power system 214. The power splitter 216 can also be coupled between the battery pack 220 and the generator unit 228 within the electric motor system 212 to control the amount of electric power delivered to the electric motor 222. When coupled in parallel, the power splitter 216 can be mechanically coupled with the electric motor system 212 and the ICE power system 214 at one end and with the remainder of the drivetrain 202 at the other end. When coupled in series-parallel, the power splitter 216 can be mechanically coupled with the electric motor system 212 and the ICE power system 214 at one end and with the remainder of the drivetrain 202 at the other end. In this configuration, the ICE power system 214 can be mechanically coupled with the electric motor system 212 to deliver mechanical power thereto.

In any of the configurations of the drivetrain 202, the power splitter 216 can control transfer of the power (e.g., mechanical or electrical) from the electric motor system 212 (e.g., originating from the electric motor 222) and from the ICE power system 214 (e.g., originating from the internal combustion engine 234) to other components of the drivetrain 202, such as the differential unit 218, the transmission shaft 236, and the axles 238. The power splitter 216 can include one or more components (e.g., gears, ring couplers, trains, or induction motor) to control transfer. In controlling, the power splitter 216 can constrain or allow transfer of at least a portion of the mechanical power from the electric motor system 212 and at least a portion of the mechanical power from the ICE power system 214. For example, the power splitter 216 can permit 60% of the mechanical power from the electric motor system 212 and 40% of the mechanical power from the ICE power system 214 to be transferred to the remainder of the drivetrain 202. The power splitter 216 can also constrain or allow transfer of at least a portion of the power from the ICE power system 212 via the generator unit 228 and at least a portion of the electrical power from the battery pack 220. The electrical power from the generator unit 228 can originate from the mechanical power delivered to the electric motor system 212 by the ICE power system 214.

The vehicle 105 can include a set of vehicle controls 206 (sometimes referred herein as car controls). The vehicle control 206 can be disposed in a passenger compartment of the vehicle 105. The vehicle control 206 can be electrically coupled with other components of the vehicle 105, such as the drivetrain 202. The vehicle control 206 can include a set of input/output components to set or control various functionalities of the vehicle 105 relating to motion of the vehicle 105 and the operations of the drivetrain 202. The vehicle control 206 can include, for example, an accelerator pedal, a brake pedal, a gear stick, and a clutch pedal, among others. Using the vehicle control 206, an occupant (e.g., the driver) within the vehicle 105 can control the steering, braking, and acceleration of the vehicle 105. The vehicle control 206 can monitor for an input from the occupant of the vehicle 105. The input can correspond to a command to be applied to the drivetrain 202 to set the propulsion of the vehicle 105. For example, the input can correspond to an amount of increase in the speed of the vehicle 105. Upon receipt, the vehicle control 206 (or another component of the vehicle 105) can convert the input into the command to a power command to be applied to the drivetrain 202. The command can be provided (e.g., via an electrical coupling) to one or more components of the drivetrain 202, such as the differential unit 218, The differential unit 218 can in turn control the population of the vehicle 105 in accordance with the command received via the vehicle control 206. The vehicle control 206 of the vehicle 105 may lack any input/output component to indicate (e.g., via user input) which type of environment 100 the vehicle 105 is traversing.

The vehicle 105 can include one or more instrumentation units 204 (sometimes referred herein as engine instrumentation units or sensors). Each instrumentation unit 204 can be disposed within the vehicle 105. The instrumentation units 204 can acquire a set of measurements on the vehicle 105 during the operation of the vehicle 105. A single instrumentation unit 204 or multiple instrumentation units 204 can be used to acquire various types of measurements. The set of measurements acquired by the instrumentation units 204 can also include one or more engine measurements. The engine measurements can relate to the performance of the drivetrain 202 in controlling the propulsion of the vehicle 105 while traveling through the environment 100.

The engine measurements acquired via the instrumentation unit 204 can include various metrics regarding the electric motor system 212 and the ICE power system 214 of the drivetrain 202. The sampling time window for each measurement can define an amount of time over which the set of measurements are taken, and can range between 30 seconds to 10 minutes. The engine measurements can include, for example: a fuel use measurement by the ICE power system 214, an engine temperature of the internal combustion engine 234, a battery use measurement by the electric motor system 212, a battery temperature of the battery pack 220, and a charge metric of the electric motor system 212, a power command applied to the drivetrain 202 via the set of vehicle controls 206, among others. The fuel use measurement can indicate an amount or a rate of the fuel consumed from the fuel reservoir 232 by the internal combustion engine 234. To keep track of the fuel use measurement, the instrumentation unit 204 can include, for example, a fuel gauge within the cavity of the fuel reservoir 232 holding the fuel. The engine temperature can indicate an amount of heat released from the internal combustion engine 234 in providing mechanical power. To measure the engine temperature, the instrumentation unit 204 can include, for example, a thermistor or a thermometer proximate to the internal combustion engine 234. The battery temperature can indicate an amount of heat released from the battery pack 220 in providing electric power. To measure the battery temperature, the instrumentation unit 204 can include, for example, a thermistor or a thermometer proximate to the battery pack 220. The charge metric can indicate an amount of charge, a rate of charging, or a rate of discharge from various components of the electric motor system 212, such as the battery pack 220, the capacitor unit 226, and the generator unit 228. To measure the charge metric, the instrumentation unit 204 can use various voltage or current measurement techniques, such as a chemical method, a voltage method, and coulomb counting, among others. The power command (e.g., acceleration, cruising, or braking) acquired by the instrumentation unit 204 can be received or intercepted from the set of vehicle controls 206. The engine measurements can include statistical metrics over the time window, such as an average, a minimum, a maximum, a variance, a standard deviation, and skewness, among others.

The vehicle 105 can include at least one vehicle control unit 208. The vehicle control unit 208 can include hardware components (e.g., one or more processors or memory) or a combination of hardware components and software, as detailed herein in conjunction with FIG. 6. The components of the vehicle control unit 208 can be disposed in the vehicle 105. The vehicle control unit 208 can include logical circuitry (e.g., a central processing unit) that responses to and processes instructions fetched from a memory unit. For example, the vehicle control unit 208 can be implemented as one or more printed circuit boards (PCBs) with various hardware components arranged thereon. The central processing unit can utilize instruction level parallelism, thread level parallelism, different levels of cache, and multi-core processors. A multi-core processor can include two or more processing units on a single computing component. The vehicle control unit 208 can be a type of an electronic control unit (ECU) disposed in the vehicle 105 to control various operations and functionalities of the drivetrain 202. In controlling the drivetrain 202, the vehicle control unit 208 can set or define the power to be consumed by the drivetrain 202. The vehicle control unit 208 can also include at least one communications interface to communicate with one or more components within the vehicle 105 and with components outside the vehicle 105 (e.g., via a wireless communications).

The system 200 can include at least one server 210 (sometimes referred herein as a data processing system). The server 210 can include at least one server with one or more processors, memory, and a network interface, among other components. The server 210 can include a plurality of servers located in at least one data center, a branch office, or a server farm. The server 210 can include multiple, logically-grouped servers and facilitate distributed computing techniques. The logical group of servers may be referred to as a data center, server farm or a machine farm. The servers can be geographically dispersed. A data center or machine farm may be administered as a single entity, or the machine farm can include a plurality of machine farms. The servers within each machine farm can be heterogeneous: one or more of the servers or machines can operate according to one or more type of operating system platform. The server 210 can include servers in a data center that are stored in one or more high-density rack systems, along with associated storage systems, located for example in an enterprise data center. The server 210 with consolidated servers in this way can improve system manageability, data security, the physical security of the system, and system performance by locating servers and high performance storage systems on localized high performance networks. Centralization of all or some of the server 210 components, including servers and storage systems, and coupling them with advanced system management tools, allows more efficient use of server resources, which saves power and processing requirements and reduces bandwidth usage. Each of the components of the server 210 can each include at least one processing unit, server, virtual server, circuit, engine, agent, appliance, or other logic device such as programmable logic arrays configured to communicate with other computing devices, such as the vehicle control unit 208 in the vehicle 105. The server 210 can include at least one communications interface to communicate with devices such as the vehicle control unit 208 residing in the vehicle 105 (e.g., via a wireless communications).

The server 210 can include at least one cycle extractor 252. The cycle extractor 252 executing on the server 210 can access at least one database 260 to retrieve or identify at least one sample driving cycle 262 (sometimes herein referred to as a driving measurement). A set of sample driving cycles 262 can be maintained on the database 260 included in the server 210 or otherwise communicatively coupled with the server 210. Each sample driving cycle 262 can include a set of measurements of a vehicle (e.g., the vehicle 105) traveling in various types of environments 100 (e.g., the urban environment 110, the mountainous terrain 115, the suburban environment 120, or the highway 125) over a sampling time window. The time duration for each sample driving cycle 262 can define an amount of time over which the set of measurements are taken, and can range between 30 seconds to 1 hour. The time duration for the sample driving cycle 262 can be the same as or can differ from the sampling time window used by the instrumentation unit 204 in the vehicle 105.

The cycle extractor 252 can parse each sample driving cycle 262 to identify the measurements. The measurements in the sample driving cycles 262 may have been acquired from test runs of vehicles 105 in one of the types of environments 100 over one or more sampling time windows. The sample driving cycles 262 can be updated, and new sample driving cycles 262 can be received and maintained by the server 210 for additional processing. The measurements in each sample driving cycle 262 can include engine measurements, among others. The engine measurements can include, for example: a fuel use measurement by the ICE power system 214, an engine temperature of the internal combustion engine 234, a battery use measurement by the electric motor system 212, a battery temperature of the battery pack 220, and a charge metric of the electric motor system 212, among others. The engine measurements in each sample driving cycle 262 can include statistical metrics of over the sampling time window, such as an average, a minimum, a maximum, a variance, a standard deviation, and skewness, among others.

Using the identified measurements, the cycle extractor 252 can generate a set of reference engine characteristics 268 (sometimes referred herein as reference engine measurements or more generally as engine measurements). The reference engine characteristics 268 can correspond to or include the engine measurements identified from the corresponding sample driving cycle 262. The cycle extractor 252 can calculate a range about each engine measurement for the reference engine characteristics 268. For example, the cycle extractor 252 can determine a range of +/−10% for the fuel use measurement, the engine temperature, the battery use measurement, the battery temperature, and the charge metric, among others. The cycle extractor 252 can generate the reference engine characteristics 268 using type of data structure, such as an array, a matrix, a linked list, a binary tree, a heap, a hash-based structure, and a graph, among others. Upon generation, the cycle extractor 252 can store and maintain the set of reference engine characteristics 268 on the database 260.

The server 210 can include at least one condition classifier 254. The condition classifier 254 executing on the server 210 can also access the database 260 to identify the sample driving cycle 262. The sample driving cycle 262 can include the measurements of the vehicle 105 traveling through one of the types of the environment 100 (e.g., the urban environment 110, the mountainous terrain 115, the suburban environment 120, or the highway 125) over the sample interval. The condition classifier 254 can categorize or identify at least one environmental condition 270 that the measurements from the vehicle 105 correspond to. The environmental condition 270 can indicate at least one type of environment 100 from which the measurements for the sample driving cycle 262 is acquired. The environmental condition 270 can include one or more of: the urban environment 110, the mountainous terrain 115, the suburban environment 120, or the highway 125, among others. The condition classifier 254 can identify the environmental condition 270 based on the sample driving cycle 262. The sample driving cycle 262 can include a label for the type of environment 100 the measurements correspond to. For example, each sample driving cycle 262 can be pre-labeled as corresponding to one of the urban environment 110, the mountainous terrain 115, the suburban environment 120, or the highway 125. The condition classifier 254 can parse the label to identify the type of environment 100 to which the measurements of the sample driving cycle 262 as the environmental condition 270. The condition classifier 254 can classify, categorize, or otherwise associate the measurements of the sample driving cycle 262 as the environment. The condition classifier 254 can store and maintain the association between the environmental condition 270 and the reference engine characteristics 268 onto the database 260.

The condition classifier 254 can apply at least one clustering algorithm to determine or identify the type of environment 100 that the measurements of the sample driving cycle 262 corresponds to. The clustering algorithm can include, for example, a regression algorithm (e.g., a linear regression model or a logistic regression model), a support vector machine (SVM), a k-means clustering algorithm, a Gaussian mixture model, a density-based clustering algorithm, and a discriminant analysis, among others. At least a subset of the sample driving cycles 262 can have a label corresponding to one of the types of environment 100. The label can indicate that the measurements included in the sample driving cycle 262 is acquired from one of the environments 100. The condition classifier 254 can generate a reference engine characteristics 268 for each sample driving cycle 262 with the labeling. The condition classifier 254 can identify a feature space in which the reference engine characteristics 268 of the sample driving cycles 262 are defined.

With the identification, the condition classifier 254 can apply the clustering algorithm on the reference engine characteristics 268 in the feature space to determine a classification map. The application of the clustering algorithm can include reference engine characteristics 268 from sample driving cycles 262 without any labeling as to which environment 100 the measurements are acquired. The clustering algorithm may be run multiple times until convergence. The classification map can define one or more regions of the feature space corresponding to one of the types of the environment 100. For example, the classification map can define at least one region for the urban environment 110, at least one region for the mountainous terrain 115, at least one region for the suburban environment 120, and at least one region for the highway 125. Each reference engine characteristics 268 generated from one of the sample driving cycles 262 can be assigned to one of the regions corresponding to the type of environment 100. The condition classifier 254 can identify the region to which the reference engine characteristics 268 for the corresponding sample driving cycle 262 is assigned.

Using the identification, the condition classifier 254 can classify, categorize, or otherwise identify the type of environment 100 defined by the region of the classification map as the environmental condition 270. The condition classifier 254 can associate the identified environmental condition 270 with the reference engine characteristics 268 generated from the same sample driving cycle 262. For each set of reference engine characteristics 268 from sample driving cycles 262 without labeling, the condition classifier 254 can identify the environment condition 254 from the region in the classification map to which the reference engine characteristics 268 is assigned. The condition classifier 254 can store and maintain the association between the environmental condition 270 and the reference engine characteristics 268 onto the database 260. The condition classifier 254 can store and maintain the classification map used to categorize onto the database 260.

The server 210 can include at least one power optimizer 256. The power optimizer 256 executing on the server 210 can determine or generate at least one distribution ratio 272 for each sample driving cycle 262. Each distribution ratio 272 can specify allocations of power to be drawn via the power splitter 216 from the electric motor system 212 and from the ICE power system 214. The distribution ratio 272 can specify the power splitter 216 to draw one power allocation from the electric motor system 212 (or the electric motor 222) and one power allocation from the ICE power system 214 (or the internal combustion engine 234). The power allocations in the distribution ratio 272 between the electric motor system 212 and the ICE power system 214 can be relative to one another. For example, the distribution ratio 272 can specify a proportion (e.g., fraction or percentage) of the mechanical power to be drawn from the electric motor system 212 and a proportion of the mechanical power to be drawn from the ICE power system 214. In this example, the proportions of the mechanical power to be drawn from both sources can total 100% or 1.0.

In generating the distribution ratio 272, the power optimizer 256 can calculate or determine the power allocations for the electric motor system 212 and the ICE power system 214 to satisfy an optimal power consumption based on the engine measurements. The optimal power consumption can correspond to the amount of power drawn from both sources to maintain a target battery performance in the electric motor system 212 and a fuel consumption in the ICE power system 214. For certain reference engine characteristics 268 and environmental conditions 270, the optimal power consumption can be achieved when more power is drawn from the ICE power system 214 than the electric motor system 212, and vice-versa. The power optimizer 256 can perform one or more simulations with different power allocations between the electric motor system 212 and the ICE power system 214. The simulations can include the reference engine characteristics 268 and the environmental condition 270 as parameters (e.g., optimization constraints). The different power allocation can be generated in accordance with a random sampling technique, such as a Monte Carlo method, a Sobol sequence, or a pseudo-random sampling, among others.

From each simulation, the power optimizer 256 can determine a resultant performance of the drivetrain 202 in the simulation. The resultant performance can include a battery performance of the electric motor system 212 and fuel consumption by the ICE power system 214 over the sampling interval. Between each simulation, the power optimizer 256 can determine whether the power allocation satisfies the optimal power consumption. The determination can be in accordance with an optimization algorithm, such as dynamic programming, a convex optimization technique, or a constrained non-linear algorithm. The optimization process may be then carried out for each traction motor power trajectory acquired from each simulation. The power splitting may be optimized along each trajectory to obtain overall minimum combined losses in the electric motor system 212 and the ICE power system 214. The determination can also be in accordance with a machine learning model, such as an artificial neural network (ANN), a support vector machine (SVM), a Bayesian network, a regression model (e.g., linear or logistic regression), and a clustering model, among others. For example, the power optimizer 256 can compare the resultant performances from multiple simulations.

In comparing, the power optimizer 256 can construct a topologic space (e.g., a function) using the resultant performances. From the space, the power optimizer 256 can identify the resultant performance corresponding to a global extremum point (e.g., a maxima or a minima) among the resultant performances. From the extremum point, the power optimizer 256 can determine the power allocations to the electric motor system 212 and to the ICE power system 214. With the determination, the power optimizer 256 can identify the power allocations as the distribution ratio 272 between the electric motor system 212 and the ICE power system 214. The power optimizer 256 can associate the distribution ratio 272 with the set of reference engine characteristics 268 and the environmental condition 270 used to determine the distribution ratio 272. The power optimizer 256 can store and maintain the distribution ratio 272 and the association on the database 260.

The server 210 can include at least one table generator 258. The table generator 258 executing the server 210 can generate at least one power splitting ratio (PSR) table 264 (sometimes referred herein generally as a set of power distribution profiles) encompassing the set of sample driving cycles 262. For each sample drive cycle 262, the optimal power splitting ratio along the trajectory can be then summarized into the PSR table 264 in terms of the traction motor power request, battery temperature and battery state-of-charge, among other variables. In the real-time system, the vehicle control unit 208 can look up the stored optimal power splitting ratio from the table based on the current operating condition (i.e., power request, battery temperature, battery state-of-charge). Such splitting ratio can facilitate in the determination of power allocation from the electric motor system 212 and the ICE power system 214. In generating the PSR table 264, the table generator 258 can generate at least one power distribution profile 266 for each sample driving cycle 262. Each power distribution profile 266 can correspond to at least one entry of the PSR table 264. The power distribution profile 266 can be generated by the table generator 258 to include the set of reference engine characteristics 268, the environmental condition 270, and the distribution ratio 272 for the corresponding sample driving cycle 262. For each sample driving cycle 262, the table generator 258 can identify: the set of reference engine characteristics 268, the environmental condition 270, and the distribution ratio 272. With the identification, the table generator 258 can bundle, combine, or otherwise generate the power distribution profile 266 using the set of reference engine characteristics 268, the environmental condition 270, and the distribution ratio 272. The table generator 258 can store and maintain the power distribution profile 266 of the PSR table 264 on the database 260 for provision to the vehicle control unit 208 of the vehicle 105. The PSR table 264 or the power distribution profile 266 can be any type of data structure, such as an array, a matrix, a linked list, a binary tree, a heap, a hash-based structure, and a graph, among others. The table generator 258 can arrange each power distribution profile 266 on the database 260 with an index identifier.

The vehicle control unit 208 can include at least one table maintainer 242. The table maintainer 242 executing on the vehicle control unit 208 can store and maintain at least one power distribution profile 266 on at least one database 250. The database 250 can be memory or a storage disposed in vehicle 105 and can be communicatively coupled with the one or more processors forming the vehicle control unit 208. The table maintainer 242 can fetch, retrieve, or otherwise receive at least one power distribution profile 266 or the set of power distribution profiles 266 in the form of the PSR table 264 from the server 210. To retrieve, the table maintainer 242 can establish a communication session 274 with the server 210. For example, when the vehicle 105 is located within an effective radius of a network access point, the communication interface of the vehicle control unit 208 can establish the communication session with 258 the server 210 via the network access point. The network access point can include a cellular base station, a wireless router, or a wired network connection, among others.

Once established, the table maintainer 242 can send a request to the server 210 via the communication session 274. The request can be sent via the server 210 in response to the establishment of the communication session 274. The request can be to update the power distribution profiles 266 in the PSR table 264 already stored on the database 250 of the vehicle control unit 208. With receipt of the request, the table generator 258 running on the server 210 can access the database 260 to identify the set of power distribution profiles 266. The identified set of power distribution profiles 266 in the PSR table 264 can be all of the power distribution profiles 266 generated using the sample driving cycles 262. The table generator 258 on the server 210 can return, transmit, or send the set of power distribution profiles 266 to the vehicle control unit 208 via the communication session 274. In turn, the table maintainer 242 can receive the set of power distribution profiles 266 from the server 210. The table maintainer 242 can store and maintain the set of power distribution profiles 266 on the database 250 for use by the other components of the vehicle control unit 208. Each power distribution profile 266 can include the set of reference characteristics 268, the identified environmental condition 270, and the distribution ratio 272.

The vehicle control unit 208 can include at least one measurement aggregator 244. The measurement aggregator 244 executing on the vehicle control unit 208 can retrieve, receive, or otherwise identify the measurements acquired by one or more of the instrumentation units 204. The measurements identified from the instrumentation unit 204 can include the engine measurements. The measurement aggregator 244 can identify the measurements from the instrumentation unit 204 using a moving time window. The time window can define an amount of time elapsed between one identification of the measurements to the subsequent identification of measurements. The time window can overlap for one identification of measurements can partially overlap with the time window for the next identification of measurements. The time window can correspond to the sampling time window to allow for the accumulation of measurements. The length of the time window can equal the sampling time window, and can range between 30 seconds to 10 minutes. The length of the time window used for the measurements can be preset. The engine measurements can include a fuel use measurement by the ICE power system 214, an engine temperature of the internal combustion engine 234, a battery use measurement by the electric motor system 212, a battery temperature of the battery pack 220, and a charge metric of the electric motor system 212, among others. The engine measurements can include various statistical metrics of each type of measurement over the sampling time window, such as an average, a minimum, a maximum, a variance, a standard deviation, and skewness, among others.

The vehicle control unit 208 can include at least one pattern recognizer 246. The pattern recognizer 246 executing on the vehicle control unit 208 can compare the identified engine measurements from the instrumentation unit 204 with the set of reference engine characteristics 268 in each power distribution profile 266 of the PSR table 264. In comparing, the pattern recognizer 246 can input or feed the identified engine measurements into the PSR table 264. The engine measurements from the instrumentation unit 204 can be within the range defined by one of the sets of reference engine characteristics 268 in one of the power distribution profiles 266. Based on the comparison, the pattern recognizer 246 can identify the power distribution profile 266 from the PSR table 264 that has the set of reference characteristics 268 matching or satisfying (e.g., within the range) of the identified engine measurements. With the identification, the pattern recognizer 246 can identify or select the power distribution table 266 from the PSR table 264 for additional processing.

With the selection of one of the power distribution profiles 266 from the PSR table 265, the pattern recognizer 246 can parse the power distribution profile 266 to identify the environmental condition 270. The environmental condition 270 can indicate one of the types of environment 100, such as the urban environment 110, the mountainous terrain 115, the suburban environment 120, or the highway 125, among others. The environmental condition 270 indicated by the power distribution profile 266 correspond to the type of environment 100 the vehicle 105 is traveling through, as indicated by the engine measurements from the instrumentation unit 204. The power distribution table 266 selected by the pattern recognizer 246 can also include the distribution ratio 272 determined by the server 210 to have the most optimal performance of the drivetrain 202.

The vehicle control unit 208 can include at least one drivetrain controller 248. The drivetrain controller 248 executing on the vehicle control unit 208 can identify the distribution ratio 272 from the power distribution profile 266 selected from the PSR table 264. The distribution ratio 272 can specify allocations of power to be drawn via the power splitter 216 from the electric motor system 212 and from the ICE power system 214 (e.g., by proportion or ratio). With the selection of the power distribution profile 266, the drivetrain controller 248 can identify the power allocation for the electric motor system 212 and the power allocation for the ICE power system 214 as indicated by the distribution ratio 272. Using the distribution ratio 272, the drivetrain controller 248 can also identify the power allocation to be drawn from the electric motor system 212 and the power allocation to be drawn from the ICE power system 214 via the power splitter 216. Each power allocation can be defined in proportion to the other. For example, the drivetrain controller 248 can determine that 30% of the power from the electric motor system 212 and 70% of the power from the ICE power system 214 is to be transferred to the remainder of the drivetrain 202 using the distribution ratio 272.

In accordance with the allocations specified by the distribution ratio 272, the drivetrain controller 248 can configure or set the power splitter 216 to transfer mechanical power from the electric motor system 212 (e.g., the electric motor 222) and the ICE power system 214 (e.g., the internal combustion engine 234) to the other components of the drivetrain 202, such as the differential unit 218, the transmission shaft 236, and the axles 238, among others. The drivetrain controller 248 can generate and send one or more commands to the power splitter 216 to effectuate the power allocation. The command can specify the amount of power to be drawn from electric motor system 212 and the amount of power to be drawn from the ICE power system 214 through the drivetrain 202 in propelling the vehicle 105 through the environment 100.

To configure the power splitter 216, the drivetrain controller 248 can determine a power value to draw from the electric motor 222 of the electric motor system 212 and a power value to draw from the internal combustion engine 234 of the ICE power system 214. The power value can specify an amount of mechanical power to be outputted from each power source (e.g., the electric motor 222 and the internal combustion engine 234). The power value for each power source can be in proportion to each other. The drivetrain controller 248 can determine or identify a total power outputted by the drivetrain 202. The drivetrain controller 248 can determine the power values to draw from electric motor system 212 and the ICE power system 214 based on the total power and the distribution ratio 272. For example, the power values can lead to drawing 80% of power from the ICE power system 214 and 20% of power from the electric motor system 212 as specified by the distribution ratio 272 of the selected power distribution profile 266. Upon determination, the drivetrain controller 248 can apply the power values (e.g., using the commands) to the power splitter 216. The power splitter 216 in turn can draw from each power source in accordance with the determined power values.

The drivetrain controller 248 can hold and maintain the application of the power allocations to the drivetrain 202 for a moving time window. The time window can define an amount of time elapsed between one application (and holding) of the power allocations and the subsequent application (and holding) of the power allocations determined from the distribution ratio 272. The time window can overlap for one application of the power allocations can partially overlap with the time window for the next application of the power allocations. The time window for the power allocations can correspond to the time window between identification of the measurements to the subsequent identification of measurements. For example, the time window for the power allocations can be offset by a set time subsequent to the time window for the identification of the measurements. The time window can correspond to the sampling time window to allow for the accumulation of measurements. The time window for the application of power allocations can also differ or can be independent of the sampling time window. For example, the power allocation can be applied until the subsequent power command is detected via the vehicle controls 206. The time window for the application of the power allocations can and can range between 0.1 seconds to 5 minutes.

While applying the determined power allocations, the drivetrain controller 248 can detect at least one power command applied via one or more of the vehicle controls 206. For example, the drivetrain controller 248 can detect the driver of the vehicle 105 pressing on the acceleration pedal (an example of a vehicle control 206) to increase speed. The power command can indicate a setting (e.g., increase, decrease, or maintain) of the velocity or acceleration of the vehicle 105 through the environment 100. Based on the power command received via the vehicle control 206, the drivetrain controller 248 can set, change, or otherwise adjust the configuration of the power splitter 216. The adjustment to the configuration of the power splitter 216 can result in a change in the transfer of the mechanical power from the electric motor system 212 or from the ICE power system 214, or both, to the other components of the drivetrain 202 (e.g., the differential unit 218). In response to detecting the power command, the drivetrain controller 248 can determine a total power to be drawn from both sources of the drivetrain 202 to achieve the new target speed or acceleration. Based on the total power to be provided in response to the power command, the drivetrain controller 248 can determine a power value to draw from the electric motor 222 of the electric motor system 212 and a power value to draw from the internal combustion engine 234 of the ICE power system 214 in accordance with the distribution ratio 272.

In this manner, the vehicle control unit 208 can configure the power to be drawn from multiple sources of power in the drivetrain 202 of the hybrid vehicle 105 while traveling through the environment 100 based on on-board engine measurements. By receiving the PSR table 264 from the server 106, the involvement of the vehicle control unit 208 in determining and generating power allocations can be reduced, thereby saving computing resources. The determination and generation of such power distributions can be at least partially offloaded onto the server 210, which can have far greater computing resources than the vehicle control unit 208. Because such calculations are offloaded, other electronic control units in the vehicle 105 can lack configuration to control power allocations of the drivetrain 202 of the vehicle 105 using measurements from specialized sensors. In addition, such electronic control units can also lack complex or specialized hardware to perform calculations in regards to setting parameters to control the drivetrain 202.

FIG. 3, among others, depicts a flow diagram of a method 300 of allocating power distribution in drivetrains of hybrid vehicles. The functionalities of the method 300 can be implemented or performed by the various components of the vehicle 105 as detailed herein above in conjunction with FIGS. 1 and 2 or the computing system 600 as described herein below on FIG. 6, or any combination thereof. Under method 300, the functionalities of (305)-(330) can be performed offline or remotely from the vehicle control unit 208 of the vehicle 105, such as the server 210. The functionalities of (335)-(355) can be performed in real-time, or on the vehicle control unit 208 as the vehicle 105 is traveling through the environment 100.

The server 210 can retrieve drive cycle profiles from a database (305). The server 210 can perform dynamic programming optimizations using the drive cycle profiles (310). Based on the dynamic programming optimization, the server 210 can determine an optimized power splitting ratio (PSR) table (315). In conjunction, the server 210 can classify each driving cycle to an associated driving pattern, such as a city, a highway, a suburb, or a mountain (320). The server 210 can associate the PSR table with the associated driving pattern label (325). The server 210 can store the reference PSR tables onto a database (330). The vehicle control unit 208 can acquire vehicle operating data (335). The vehicle control unit 208 can determine a vehicle driving pattern using the operating data (340). The vehicle control unit 208 can select a PSR table corresponding to the determined driving pattern (345). The vehicle control unit 208 can receive inputs, such as a vehicle power command, battery temperature, and state of charge, among others (350). Based on the inputs, the vehicle control unit 208 can determine a PSR value from the PSR table (355). The vehicle control unit 206 can apply a command for power distribution to the battery pack and engine of the vehicle 105 (360).

FIG. 4, among others, depicts a flow diagram of a method 400 of allocating power distribution in drivetrains of hybrid vehicles. The functionalities of the method 400 can be implemented or performed by the various components of the vehicle 105 as detailed herein above in conjunction with FIGS. 1 and 2 or the computing system 600 as described herein below on FIG. 6, or any combination thereof. The method 400 can include identify measurements from driving cycles 262 (405). The server 210 can parse the sample driving cycle 262 to identify motion measurements and engine measurements of a vehicle 105 in a test run for the sample driving cycle 262. Both measurements can be defined over a sampling time window. The engine measurements can include a fuel use measurement by the ICE power system 214, an engine temperature of the internal combustion engine 234, a battery use measurement by the electric motor system 212, a battery temperature of the battery pack 220, and a charge metric of the electric motor system 212, a power command applied to the drivetrain 202 via the set of vehicle controls 206, among others. The server 210 use the engine measurements identified from the sample driving cycle 262 as the set of reference engine characteristics 268.

The method 400 can include classifying driving cycle 262 to an environmental condition 270 (410). The server 210 can identify a type of environment 100 from which the sample driving cycle 262 is acquired. At least a subset of the sample driving cycles 260 can be labeled with the type of environment 100, such as the urban environment 110, the mountainous terrain 115, the suburban environment 120, or the highway 125, among others. The server 210 can use the sample driving cycles 262 with the label to identify the type of environment 100 for the other sample driving cycles 262. The server 210 apply a clustering algorithm to identify regions within the feature space corresponding to the types of environment 100. The feature space can define the engine measurements. Based on the regions of the feature space, the server 210 can assign each sample driving cycle 262 to an environmental condition 270 corresponding to one of the types of environment 100.

The method 400 can include determining power allocations (415). The server 210 can determine a distribution ratio 272 for each sample driving cycle 262. The distribution ratio 272 can specify allocations of power to be drawn via a power splitter 216 from an electric motor system 212 and from an ICE power system 214. In determining the distribution ratios 272, the server 210 can apply an optimization algorithm to satisfy an optimal energy consumption given the engine measurements of the sample driving cycle 262. The optimal energy consumption can correspond to the amount of drawn power to maintain a target battery performance in the electric motor system 212 and a fuel consumption in the ICE power system 214.

The method 400 can include generating power distribution profiles 266 (420). For each sample driving cycle 262, the server 210 can package or generate a set of power distribution profile 266 in a PSR table 264. Each power distribution profile 266 can include the set of reference engine characteristics 268, the environmental condition 270, and the distribution ratio 272 from the same sample driving cycle 262. The server 210 can store and maintain the set of power distribution profiles 266 onto the database 260. The method 400 can include transmitting the power distribution profile 266 (425). A vehicle control unit 208 and the server 210 can establish a communication session 274. Over the communication session 274, the server 210 can send the set of power distribution profiles 266 to the vehicle control unit 208. The method 400 can include receiving the power distribution profile 266 (430). Upon receipt, the vehicle control unit 208 can store and maintain the set of power distribution profiles 266 onto the database 250.

The method 400 can include identifying measurements from an instrumentation unit 204 (435). The vehicle control unit 208 can identify one or more engine measurements from the instrumentation unit 204. The engine measurements can include a fuel use measurement by the ICE power system 214, an engine temperature of the internal combustion engine 234, a battery use measurement by the electric motor system 212, a battery temperature of the battery pack 220, and a charge metric of the electric motor system 212, among others. The method 400 can include comparing the measurements (440). The vehicle control 208 can feed the engine measurements acquired form the instrumentation unit 204 into the PSR table 264 to compare the engine measurements with the reference engine characteristics 268 of each power distribution profile 266.

The method 400 can include selecting a power distribution profile 266 (445). The vehicle control unit 208 can identify the power distribution profile 266 from the PSR table 264 with the reference engine characteristics 268 within which the engine measurements from the instrumentation unit 204 fall. The method 400 can include determining the environmental condition 270 (450). The vehicle control unit 208 can identify the environmental condition 270 specified by the selected power distribution profile 266. The environmental condition 270 can be one or more of: the urban environment 110, the mountainous terrain 115, the suburban environment 120, or the highway 125, among others.

The method 400 can include determining power allocation values (455). The vehicle control unit 208 can determine the power allocation to draw power from the electric motor system 212 and the ICE power system 214 using the distribution ratio 272 of the selected power distribution profile 266. The power allocation for each power source can be relative to one another. The method 400 can include setting a power splitter 216 using the power allocation values (460). The vehicle control unit 208 can set the power splitter 216 to transfer power from the electric motor system 212 and the ICE power system 214 in accordance with the power allocation determined in accordance with the distribution ratio 272.

FIG. 5, among others, depicts a flow diagram of a method 500 of providing vehicle control units to allocate power distribution in drivetrains of hybrid vehicles. The functionalities of the method 500 can be implemented or performed by the various components of the vehicle 105 as detailed herein above in conjunction with FIGS. 1 and 2 or the computing system 600 as described herein below on FIG. 6, or any combination thereof. The method 500 can include providing a vehicle control unit 208 to allocate power in a vehicle 105 (505). The vehicle control unit 208 can installed within a vehicle 105. The vehicle control unit 208 can be coupled with one or more components of the vehicle 105 (e.g., via wired or wireless connection), such as the drivetrain 202 and a set of instrumentation unit 204, among others. In addition, the vehicle control unit 208 can include processors and memory configured to perform the functionalities of the table maintainer 242, the measurement aggregator 244, the pattern recognizer 246, and the drivetrain controller 248. The vehicle control unit 208 may have been pre-installed in the vehicle 105, and can be subsequently programmed to perform the functionalities of the table maintainer 242, the measurement aggregator 244, the pattern recognizer 246, and the drivetrain controller 248, the method 300, or the method 400, as detailed herein. For example, a script or an executable containing the functionalities can be uploaded onto the memory of the vehicle control unit 208 and can be installed to run from the vehicle control unit 208.

FIG. 6 depicts a block diagram of an example computer system 600. The computer system or computing device 600 can include or be used to implement the vehicle control unit 28 or the server 210. The computing system 600 includes at least one bus 605 or other communication component for communicating information and at least one processor 610 or processing circuit coupled to the bus 605 for processing information. The computing system 600 can also include one or more processors 610 or processing circuits coupled to the bus for processing information. The computing system 600 also includes at least one main memory 615, such as a random access memory (RAM) or other dynamic storage device, coupled to the bus 605 for storing information, and instructions to be executed by the processor 610. The main memory 615 can be or include the memory 112. The main memory 615 can also be used for storing position information, vehicle information, command instructions, vehicle status information, environmental information within or external to the vehicle, road status or road condition information, or other information during execution of instructions by the processor 610. The computing system 600 may further include at least one read only memory (ROM) 620 or other static storage device coupled to the bus 605 for storing static information and instructions for the processor 610. A storage device 625, such as a solid state device, magnetic disk or optical disk, can be coupled to the bus 605 to persistently store information and instructions.

The computing system 600 may be coupled via the bus 605 to a display 635, such as a liquid crystal display, or active matrix display, for displaying information to a user such as a driver of the electric vehicle 105. An input device 630, such as a keyboard or voice interface may be coupled to the bus 605 for communicating information and commands to the processor 610. The input device 630 can include a touch screen display 635. The input device 630 can also include a cursor control, such as a mouse, a trackball, or cursor direction keys, for communicating direction information and command selections to the processor 610 and for controlling cursor movement on the display 635. The display 635 (e.g., on a vehicle dashboard) can be part of the vehicle 105, or other component of FIG. 1 or 2, as well as part of the server 210 for example.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., various modules of the vehicle control unit 208 and the server 210), and illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “data processing system” “computing device” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, while vehicle 105 is often referred to herein by example as a hybrid vehicle 105, the vehicle 105 can include fossil fuel in addition to electric powered vehicles and examples referencing the hybrid vehicle 105 include and are applicable to other vehicles 105. Scope of the systems and methods described herein is thus indicated by the appended claims, rather than the foregoing description, and changes that come within the meaning and range of equivalency of the claims are embraced therein.

What is claimed is:

1. A system to allocate power distribution in drivetrains of hybrid vehicles, comprising:
a hybrid drivetrain disposed in a vehicle, the hybrid drivetrain comprising:
a differential unit to control propulsion of the vehicle;
an internal combustion engine to convert fuel to mechanical power to provide to the differential unit;
an electric motor to convert electrical energy drawn from a battery pack to mechanical power to provide to the differential unit; and
a power splitter to control transfer of the mechanical power from the internal combustion engine to the differential unit and of the mechanical power from the electric motor to the differential unit; and
an engine instrumentation unit disposed in the vehicle to acquire a plurality of engine measurements on the hybrid drivetrain of the vehicle, the plurality of engine measurements including a fuel use measurement of the internal combustion engine and a battery use measurement of the electric motor;
a vehicle control unit including one or more processors disposed in the vehicle, the vehicle control unit to:
maintain a plurality of power distribution profiles, each of the power distribution profiles defining a first power allocation to the internal combustion engine and a second power allocation to the electric motor specified for a plurality of engine measurements identified as associated with one of a plurality of environmental conditions;
compare the plurality of engine measurements acquired from the engine instrumentation unit with the plurality of engine measurements specified by at least one of the plurality of power distribution profiles;
select a power distribution profile from the plurality of power distribution profiles based on the comparison between the plurality of engine measurements acquired from the engine instrumentation unit with the plurality of engine measurements specified by the power distribution profile;
identify, from the power distribution profile selected from the plurality of power distribution profiles, the first power allocation to internal combustion engine and the second power allocation to the electric motor for one of the plurality of environmental conditions; and
set the power splitter to transfer of the mechanical power from the internal combustion engine and the mechanical power from the electric motor to the differential unit in accordance with the first power allocation and the second power allocation.

2. The system of claim 1, comprising the vehicle control unit to:
receive, from at least one server remote from the vehicle via a communication session, the plurality of power distribution profiles, each of the power distribution profiles generated by the at least one server by determining the first power allocation and the second power allocation to satisfy an optimal power condition in accordance with at least one of a dynamic programming optimization, a convex optimization, and a machine learning model.

3. The system of claim 1, comprising the vehicle control unit to:
receive, from at least one server remote from the vehicle via a communication session, the plurality of power distribution profiles, each of the power distribution profiles generated by the at least one server by performing a simulation to determine the first power allocation and the second power allocation.

4. The system of claim 1, comprising the vehicle control unit to:
receive, from at least one server remote from the vehicle via a communication session, the plurality of power distribution profiles, each of the power distribution profiles generated by the at least one server by classifying the plurality of engine measurements specified for the power distribution profile as at least one of the plurality of environmental conditions.

5. The system of claim 1, comprising the vehicle control unit to:
store, on memory coupled with the one or more processors, the plurality of power distribution profiles, each of the plurality of power distribution profiles defining a power distribution ratio between the first power allocation to the internal combustion engine and the second power allocation to the electric motor.

6. The system of claim 1, comprising the vehicle control unit to:
determine, based on the first power allocation and the second power allocation identified from the power distribution profile, a first power value to draw from the internal combustion engine and a second power value to draw from the electric motor; and
set the power splitter to transfer of the mechanical power from the internal combustion engine in accordance with the first power value and the mechanical power from the electric motor to the differential unit in accordance with the second power value.

7. The system of claim 1, comprising the vehicle control unit to:
detect a power command applied with via a vehicle control to control the propulsion of the vehicle, the power command indicating at least one of a velocity of the vehicle and an acceleration of the vehicle, the vehicle control including at least one of an accelerator pedal and a brake pedal; and
adjust, based on the power command detected via the vehicle control, the transfer by the power splitter of the mechanical power from the internal combustion engine and the mechanical power from the electric motor to the differential unit in accordance with the first power allocation and the second power allocation.

8. The system of claim 1, comprising the vehicle control unit to:
identify an environmental condition of the plurality of environmental conditions from the power distribution profile, the plurality of environmental conditions including at least one of a highway environment, a metropolitan environment, a suburb environment, and a mountain environment.

9. The system of claim 1, comprising the vehicle control unit to:
identify, from the engine instrumentation unit, the plurality of engine measurements over a time window at an interval corresponding to the time window, the time window defining an amount of time prior to a current time, the interval defining a time at which the sensor is to acquire the plurality of engine measurements.

10. The system of claim 1, comprising:
the engine instrumentation unit to acquire the plurality of engine measurements on the hybrid drivetrain of the vehicle, the plurality of engine measurements including a charge level of the battery pack and a temperature of the battery pack.

11. The system of claim 1, comprising:
the differential unit of the hybrid drivetrain to control the propulsion of the vehicle in accordance a power command applied with via a vehicle control, the vehicle control including at least one of an accelerator pedal and a brake pedal; and
the engine instrumentation unit to acquire the plurality of engine measurements including the power command applied via the vehicle control.

12. The system of claim 1, comprising:
an electronic control unit having one or more processors disposed in the vehicle, the electronic control unit lacking configuration to control the hybrid drivetrain based on one or more measurements.

13. A vehicle, comprising:
a hybrid drivetrain comprising:
a differential unit to control propulsion;
an internal combustion engine to convert fuel to mechanical power to provide to the differential unit;
an electric motor to convert electrical energy drawn from a battery pack to mechanical power to provide to the differential unit; and
a power splitter to control transfer of the mechanical power from the internal combustion engine to the differential unit and of the mechanical power from the electric motor to the differential unit; and
an engine instrumentation unit to acquire a plurality of engine measurements on the hybrid drivetrain, the plurality of engine measurements including a fuel use measurement of the internal combustion engine and a battery use measurement of the electric motor;
a vehicle control unit including one or more processors, the vehicle control unit to:
maintain a plurality of power distribution profiles, each of the power distribution profiles defining a first power allocation to the internal combustion engine and a second power allocation to the electric motor specified for a plurality of engine measurements identified as associated with one of a plurality of environmental conditions;
compare the plurality of engine measurements acquired from the engine instrumentation unit with the plurality of engine measurements specified by at least one of the plurality of power distribution profiles;
select a power distribution profile from the plurality of power distribution profiles based on the comparison between the plurality of engine measurements acquired from the engine instrumentation unit with the plurality of engine measurements specified by the power distribution profile;
identify, from the power distribution profile selected from the plurality of power distribution profiles, the first power allocation to internal combustion engine and the second power allocation to the electric motor for one of the plurality of environmental conditions; and
set the power splitter to transfer of the mechanical power from the internal combustion engine and the mechanical power from the electric motor to the differential unit in accordance with the first power allocation and the second power allocation.

14. The vehicle of claim 13, comprising the vehicle control unit to:
receive, from at least one server remote from the vehicle via a communication session, the plurality of power distribution profiles, each of the power distribution profiles generated by the at least one server by determining the first power allocation and the second power allocation to satisfy an optimal power condition in accordance with at least one of a dynamic programming optimization, a convex optimization, and a machine learning model.

15. The vehicle of claim 13, comprising the vehicle control unit to:
store, on memory coupled with the one or more processors, the plurality of power distribution profiles, each of the plurality of power distribution profiles defining a power distribution ratio between the first power allocation to the internal combustion engine and the second power allocation to the electric motor.

16. The vehicle of claim 13, comprising the vehicle control unit to:
determine, based on the first power allocation and the second power allocation identified from the power distribution profile, a first power value to draw from the internal combustion engine and a second power value to draw from the electric motor; and
set the power splitter to transfer of the mechanical power from the internal combustion engine in accordance with the first power value and the mechanical power from the electric motor to the differential unit in accordance with the second power value.

17. The vehicle of claim 13, comprising the vehicle control unit to:
detect a power command applied with via a vehicle control to control the propulsion of the vehicle, the power command indicating at least one of a velocity of the vehicle and an acceleration of the vehicle, the vehicle control including at least one of an accelerator pedal and a brake pedal; and
adjust, based on the power command detected via the vehicle control, the transfer by the power splitter of the mechanical power from the internal combustion engine and the mechanical power from the electric motor to the differential unit in accordance with the first power allocation and the second power allocation.

18. A method of allocating power distribution in drivetrains of hybrid vehicles, comprising:
acquiring, by an engine instrumentation engine disposed in a vehicle, a plurality of engine measurements on a hybrid drivetrain of the vehicle, the hybrid drivetrain including an internal combustion engine and an electric motor, the plurality of engine measurements including a fuel use measurement of an internal combustion engine and a battery use measurement of the electric motor;
maintaining, by a vehicle control unit having one or more processors disposed in the vehicle, a plurality of power distribution profiles, each of the power distribution profiles defining a first power allocation to the internal combustion engine and a second power allocation to the electric motor specified for a plurality of engine measurements identified as associated with one of a plurality of environmental conditions;
comparing, by the vehicle control unit, the plurality of engine measurements acquired from the engine instrumentation unit with the plurality of engine measurements specified by at least one of the plurality of power distribution profiles;
selecting, by the vehicle control unit, a power distribution profile from the plurality of power distribution profiles based on the comparison between the plurality of engine measurements acquired from the engine instrumentation unit with the plurality of engine measurements specified by the power distribution profile;
identifying, by the vehicle control unit, from the power distribution profile selected from the plurality of power distribution profiles, the first power allocation to internal combustion engine and the second power allocation to the electric motor for one of the plurality of environmental conditions; and
setting, by the vehicle control unit, a power splitter to transfer of mechanical power from the internal combustion engine and mechanical power from the electric motor to a differential unit of the hybrid drivetrain in accordance with the first power allocation and the second power allocation.

19. The method of claim 18, comprising:
receiving, by the vehicle control unit, from at least one server remote from the vehicle via a communication session, the plurality of power distribution profiles, each of the power distribution profiles generated by the at least one server by determining the first power allocation and the second power allocation to satisfy an optimal power condition in accordance with at least one of a dynamic programming optimization, a convex optimization, and a machine learning model.

20. The method of claim 18, comprising:
determining, by the vehicle control unit, based on the first power allocation and the second power allocation identified from the power distribution profile, a first power value to draw from the internal combustion engine and a second power value to draw from the electric motor; and
setting, by the vehicle control unit, the power splitter to transfer of the mechanical power from the internal combustion engine in accordance with the first power value and the mechanical power from the electric motor to the differential unit in accordance with the second power value.
